(19) United States
(12) Patent Application Publication
(10) Pub. No.: US 2009/0094132 A1
(43) Pub. Date: Apr. 9, 2009

(54) METHOD FOR FUNDRAISING BY PROVIDING CUSTOMIZED ITEMS

(76) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/867,745

(22) Filed: Oct. 5, 2007

(51) Int. Cl. G06Q 30/00; G06F 19/00

(52) U.S. Cl. 705/26

(57) ABSTRACT

In a method for providing access to and using an edutainment website original artwork created by one or more participants as part of a fundraising event and embodied in custom postage is registered on the website. Registrants or entities authorized to act on behalf of the registrants a provided with instructions regarding how to access the website. Once accessed, depending upon where within the website a registrant goes, the registrant can interact with educational and entertainment programming operable on the website.

### FIELD OF THE INVENTION

The present invention is directed in one aspect to the conduct of fundraisers wherein customized items relevant to a particular organization conducting the fundraiser, or cause associated with the fundraiser are offered for sale. The present invention is directed in another aspect to internet use and websites associated with the fundraisers.

### BACKGROUND OF THE INVENTION

Institutions such as schools, churches, charities, affinity groups and the like often use fundraising activities to generate the capital needed to offer services or even to continue in existence. These activities typically require a great deal of planning and time to implement. In addition, they are usually “one-time” activities wherein a continuous revenue stream stemming therefrom is not realizable. In addition, these fundraising activities often have limited appeal to large population segments. Moreover, they can be logistically cumbersome as the items sold are sometimes perishable and must be gathered in a common location for distribution or to be picked up. Furthermore, the items offered for sale as part of a fundraiser are sometimes large and consume a great deal of space.

Most fundraisers offer items that are not useable year round on a continuous basis. Accordingly, the need to replenish such items is minimal. In addition, it has been historically difficult for groups to maintain a sustained year-round fundraising effort. Personnel and other logistical considerations make an ongoing campaign difficult. This is particularly true where the personnel conducting the fundraising activity consist of volunteers who may have competing obligations.

There is a current need to provide a mechanism through which an organization can conduct a sustainable fundraising event having wide appeal. To facilitate such a fundraiser, the item offered for sale must be something most people have an ongoing need for and must be easily handled. The item offered must also be something that will catch the attention of potential purchasers by, for example, being personalized or having meaning specific to the particular group.

The use of the internet is becoming prevalent and popular, particularly with respect to use by children. While this provides the children with entertainment opportunities, parents and other's responsible for a child's well being must be vigilant with respect to the content these children are accessing. In addition, parents must be mindful with regard to who their children are e-mailing or where they are obtaining e-mail addresses.

The internet can also be used as a tool to promote literacy. Accordingly, there is a present need for websites usable by children that provide educational as well as entertainment value.

### SUMMARY

The present invention resides in one aspect in a method for conducting a fundraiser wherein inquiries are received or solicited from organizations regarding offering at least one customized item as part of a fundraising event conducted on behalf of the organization. A facilitating company establishes a database that performs at least one of tracking manipulating and storing information relevant to the fundraising event. Once an organization expresses an interest or states that it wishes to conduct a fundraiser, the facilitating company provides instructions to the organization regarding the manner by which the fundraiser will be conducted. Prior to the solicitation of any orders for customized items, at least one image relevant to the organization is created for display on at least one customized item. Subsequent to creation, the image is provided to the organization for approval and once approved will be displayed on the customized items.

Viewing means are provided via which at least one of the customized items can be viewed. The viewing means are unique to the organization and are accessible via notice and instructions from or on behalf of the organization. Once those given access to the viewing means have had the opportunity to view the customized items, orders are received. At least a portion of the database is populated with information relevant to the orders received. At some point either concomitant with, or subsequent to the receipt of one or more orders, payment instructions, explained in greater detail below are received. Following processing of payment, the orders are fulfilled and the customized items are delivered to purchasers thereof either directly or via distribution by the organization conducting the fundraiser.

In an embodiment of the present invention, the organization is an affinity group. As used herein, the term “affinity group” should be broadly construed to mean “a group of people sharing a common interest”. In addition, the term “customized items” should be broadly construed to include, but not be limited to, custom postage, customized checks, customized mailing labels, customized wrapping paper, calendars, gift bags, and the like.

In another aspect of the present invention the above-described images displayed on the customized items are created by the participants in the fundraiser. To facilitate the creation of original artwork by the participants, art forms are distributed to the organization. The art form may not need to be created each time an organization conducts a fundraiser. The art form can be a stocked item on hand for immediate delivery. Once the organization or the facilitating company has distributed the art forms to the fundraiser participants, each participant creates an original work of art on the art form. Orders are then solicited by the participants in the fundraiser for customized items. As part of, concomitant with, or subsequent to the order solicitations process, payment information such as credit or debit card numbers is also obtained. The art forms and order information are then forwarded to the facilitating company or entity acting on behalf of the facilitating company and electronic images of each participant's artwork are created. While the method of the present invention has been described in a manner wherein orders are solicited by the participants, the present invention is not limited in this regard. Orders may also be entered via phone, fax, mail, e-mail, or via a website established for, inter alia, accepting orders, without departing from the broader aspects of the present invention.

Each electronic image is stored and associated in the database with other information relevant to, but not limited to one or more of the particular organization and the participant in the fundraiser. While this embodiment has been described as having the participants solicit orders and forward their artwork along with the ordering information to the facilitating company or an entity on behalf thereof, the present invention is not limited in this regard. This embodiment of the present invention also contemplates that the original artwork be converted into electronic format prior to orders being solicited, and the orders being taken via a webpage whereon the customized items such as, custom checks, custom mailing labels, and/or wrapping paper bearing images of the original artwork thereon are displayed.

Preferably, the organization referred to above is a school, school system, or an affinity group. However, the present invention is not limited in this regard as other types of organizations, such as charities, companies, or even individuals or other entities attempting to raise money to cover medical expenses and the like are contemplated by the present invention.

Once the orders and payment information are received, the orders are processed and shipped to at least one of the organizations and the respective purchasers.

The present invention also resides in a method for making gifts to an organization. As used herein, the term “organization” should be broadly construed to include, inter alia, affinity groups, charities, school systems, schools, medical facilities, non-profit groups, individuals in need of assistance, and the like. This method includes developing custom postage, and/or postcards that bear an image thereon, relevant to the particular organization. In exchange for, or as a result of, receiving a donation, a donor can be provided with a predetermined quantity of custom postage and/or postcards. Depending upon the tax laws, all or a portion of the above-described donation may be tax deductible.

The present invention also contemplates a social citizenship program whereby a charitable cause is selected for which funds will be raised. A database is provided, and has software associated therewith, the database and the software being operable to perform one or more of storing, tracking, and manipulating information relevant to the social citizenship campaign. A plurality of forms upon which participants can create original artwork, are distributed either to the participants, or to the entity conducting the social citizenship campaign. If the forms are distributed to the entity conducting the social citizenship campaign, that entity will then distribute the forms to the participants. At least a portion of the participants will create original artwork on the forms. The original artwork is converted into electronic format and stored in the database similar to that described above.

One or more pieces of the original artwork relevant to the particular cause are selected to be embodied in custom postage and/or postcards. Orders are solicited for the custom postage and/or postcards and payment is received for the orders. Information relevant to the solicited orders is stored in the database. The orders are then processed. As used herein the term “processed” or “processing” should be broadly construed to mean producing the custom postage and/or postcards ordered and forwarding them to the purchasers thereof or to the entity conducting the social citizenship campaign. Once the orders are processed, an amount of funds raised to be used in connection with the cause is determined. While custom postage and/or postcards have been described, the present invention is not limited in this regard as the above-described original artwork can be embodied in other items, such as, but not limited to mugs, key chains, wrapping paper, gift bags and the like.

The present invention resides in yet another aspect in a method for providing access and use of an edutainment website. As used herein, the term “edutainment” should be broadly construed to mean having both educational and entertainment content. The method of this embodiment includes registering original artwork. Registrants or entities authorized to act on behalf of said registrants are provided with instructions regarding how to access one of, a website or an area of a website, wherein the registrants can interact with educational and entertainment programming operable on the website. Protocols, such as, but not limited to, the entry of a password, will be required to be followed by the registrants or the entities acting on behalf of the registrants in order to allow access to the educational and entertainment programming.

### DETAILED DESCRIPTION OF THE PREFERRED EMBODIMENTS OF THE PRESENT INVENTION

The present invention is directed to a method for conducting a fundraiser whereby inquiries are received by, or solicited from, an organization regarding offering at least one customized item as part of a fundraising event conducted on behalf of the organization. A database is maintained for tracking the solicitation or inquiry. Information resident in the database relevant to the fundraiser can be tracked, manipulated and/or stored therein via software associated with the database. Preferably this software can also be employed to extract information from the database to generate desired outputs. For example, at the conclusion of the fundraiser, a portion of the proceeds will be due the organization. The software associated with the database can be used to extract the information therefrom relevant to the amount due the organization and can be employed to generate a report pertaining thereto. The software described above can be part of a purchased database package, such as, for example, Microsoft Access® program, the software can be other third party software, or the software can be customized software written for the facilitating company. Moreover, the database may be established and/or managed by the facilitating company or an entity acting on behalf of the facilitating company. In addition, at the conclusion of a fundraising event, the organization conducting the fundraiser may retain the portion of the collected funds due it and forward the remainder to the facilitating company or an entity acting on behalf of the facilitating company. Similarly, the organization conducting the fundraiser can collect all of the payments from purchasers of the customized items and present the facilitating company with a single reconciled payment. This reconciled payment can be in the form of any of the above-described payment instructions. Moreover, the facilitating company conducting the fundraiser may or may not withhold the amount due it.

Once the organization has agreed to conduct a fundraiser, instructions are provided to the organization. At least one image relevant to the organization is created, by or at the behest of the company facilitating the fundraiser for display on the customized items. Preferably several images are created so that the organization can have a broad selection of images to choose from. Each of the images created will have significance relevant to the organization for which the fundraiser is being conducted. For example if the organization is an affinity group, such as an alumni association, the images may include scenes of the relevant university campus. The images can also include logos or sports team images relevant to the university. However, the present invention is not limited in this regard as other images relevant to the particular organization such as, for example, images of distinguished or famous past or present members of the organization, can be created without departing from the broader aspects of the present invention. Once the images are created the organization chooses one or more of the images for inclusion on the customized items.

The organization can also provide the above-described customized items in exchange for a donation thereto. The donor may be able to write-off 100% of the donation, within Internal Revenue Services guidelines, as a tax deduction. In addition to the images described above, the donor may also be allowed to create or otherwise provide his/her own image in the manners described herein for inclusion on the custom items.

The above-described customized items can include such things as custom postage, custom note cards, postcards, return labels, mugs, key chains and the like, each bearing at least one of the images thereon. In addition, the customized items can also include wrapping paper and gift bags. The wrapping paper or gift bags would include one or more of the images printed thereon. In addition, a purchaser may also be able to select a theme pattern and/or color scheme for the wrapping paper and gift bags. The theme could be relevant to a holiday or be event specific, such as for example a birthday theme or anniversary. Where a holiday theme is provided, a potential purchaser can be presented with several choices relevant to a particular theme. For example, for a Christmas theme, the wrapping paper and/or gift bags could include images and/or phrases unique to Christmas. In addition, the user or prospective purchaser can also be presented with several choices as to color or a color scheme for the wrapping paper. Since the wrapping paper and gift bags bear the above-described image or images unique to the particular organization the color scheme that is chosen may be complimentary to the color within the particular image or images.

The prospective purchaser may be able to select the manner in which the images and/or artwork appear on the wrapping paper and/or gift bags. In addition, the wrapping paper and/or gift bags incorporating predetermined images and/or original artwork, or a combination thereof, may also be thematic in nature. For example, the wrapping paper and/or gift bags could have a theme and patterns thereon indicative of a holiday, such as Christmas. In addition, the theme could be relevant to a particular event such as a birthday or anniversary. Accordingly, the prospective purchaser may wish to procure more than one type of wrapping paper and/or gift bags, customized to have one or more desired images thereon.

In addition to original artwork, the custom wrapping paper and/or gift bags can bear images selected from a gallery of images provided by the facilitating company. These images may be accessed from a webpage accessible by a prospective purchaser. Where original artwork is being displayed thereon, more than one piece of artwork may be placed on the wrapping paper and/or gift bags. For example, it may be desirable to have the artwork of two or more siblings displayed on the wrapping paper and/or gift bags.

In addition, the present invention also contemplates incorporating other images such as photographs into the wrapping paper and/or gift bags. For example, where a school is conducting the fundraiser, a child's school picture, alone or in combination with a class picture or other picture may be incorporated into the wrapping paper and/or gift bags. In this instance these pictures would preferably be supplied to the facilitating company in electronic format for incorporation into the wrapping paper and/or gift bags. However, the present invention is not limited in this regard as the photographs can also be provided to the facilitating company or entity acting on behalf of the facilitating company who then would convert them into an electronic format. Preferably, the images as well as the wrapping paper and/or gift bag themes, patterns and color schemes will be internet accessible in the above described manner. However, the present invention is not limited in this regard as the wrapping paper and/or gift bag themes, patterns, color schemes and images for incorporation thereon can be manually selected and forwarded to the facilitating company for production.

Viewing means unique to the organization and accessible via notice therefrom or on behalf thereof, are provided by which at least one customized item having the at least one image displayed thereon can be viewed by the organization. In the preferred embodiment of the present invention the viewing means include a web page having an URL unique to the organization. The webpage can also be protected via security protocols, such as, but not limited to, a password. In addition to being able to view the custom items on the webpage, a user accessing the page may also be able to make choices with respect to colors or patterns to be included on the custom items. For example, where a user is purchasing customized wrapper paper, via the webpage or links included thereon, a user or prospective purchaser may be able to choose a theme, color scheme, pattern, and the manner by which the images will be displayed on the wrapper paper. In the preferred embodiment of the present invention, once the webpage is established the facilitating company either notifies the organization which then contacts those participating in the fundraiser, or the facilitating company, contacts the participants in the fundraiser advising them of the manner by which the webpage can be accessed.

In this embodiment, orders for the customized items are received by the facilitating company, preferably by placing the orders electronically via the webpage at which the custom items are viewed. Ordering information may be accessible directly on the webpage or via a link to an ordering page. While electronic ordering has been described, the present invention is not limited in this regard as other ordering means can be employed, such as, ordering via the mail, fax or telephone. Moreover, while electronic ordering information via the webpage, or a link on the webpage where custom items can be viewed has been described, the present invention is not limited in this regard as orders may be placed electronically via a wholly separate webpage or website that is not accessible via a link on the webpage where the custom items are viewed.

In addition to ordering custom items in the above-described manner, payment information and order information regarding, inter alia, the quantity of customized items ordered can also be transmitted to the facilitating company. Payment information/instructions are received and processed by the facilitating company or another entity on behalf of the facilitating company. These payment instructions can take several different forms. For example, payment may be made electronically by credit or debit card by entering the relevant information into a payment section of the above-described webpages or via a separate payment webpage. The credit or debit card information along with the ordering information is then forwarded to the facilitating company for processing. Payment information can also be processed by accessing an internet payment system, such as, for example, Paypal®. While electronic payment has been described, the present invention is not limited in this regard, as payment may also be made by cash, check or money order, or via credit or debit card with the credit or debit card information being transmitted by fax, mail, e-mail, or the like.

Subsequent to, or simultaneously with the placement of an order, the above-described database can be populated with information relevant to the received orders. The database may be populated manually or directly if the orders are placed electronically. If the database is populated directly, it may be necessary for the software associated with the database to be operable to facilitate the population thereof. The order information entered into the database may include such things as, but is not limited to, the name of the person placing the order, the type and number of custom items ordered, the organization for which the particular fundraiser is being conducted, the method of payment and the shipping address to which the custom items are to be sent.

Once the necessary information is received, the orders are fulfilled and the custom items sent to the purchasers thereof. Upon completion of the fundraiser, the facilitating company calculates, either manually or by employing the software associated with the database, the percentage of the proceeds that are due to the organization and once calculated forwards the funds to the organization. In addition, a portion of the proceeds from the fundraiser may be allocated to a scholarship or other type of assistance fund. For example, a fund used to defray medical expenses of the members or others designated by the organization conducting the fundraiser may be established. This fund may be managed by the facilitating company or another organization.

The software associated with the database can have the ability to manipulate the information in the database to generate desired outputs. For example, financial reports, demographic reports, and the like may be generated.

A unique organization identification code can be established and associated with the information stored in the database. The organization code can be generated by the software associated with the database automatically upon entry of initial information into the database. The organization code may also be established manually and can be manually associated with the relevant information stored in the database. The organization identification code can be random or be as straightforward as the organization's name.

Once entered, information is extracted from the database and used to generate the above-described art forms upon which participants in the fundraising event can create their own unique artwork. The art forms are preferably made from paper with a portion of the form delineated as the area of the art form on which the original artwork is to be created. The organization identification code is associated with the art forms, preferably in the form of a bar code printed directly on the art forms. However, the present invention is not limited in this regard as other indicia such as, for example, a form number, can be associated with the organization code without departing from the broader aspects of the present invention. Once generated, a plurality of the art forms are distributed to the organization and thereby to the participants in the fundraising event. It may not be necessary for the facilitating company to generate the art form as they may also maintain a stock of the art forms on hand. In such instances and as described above, it may only be necessary to associate a number or other indicia on the art form with the organization code. However, the present invention is not limited in this regard as there may also be no need to associate the particular art forms with the organization prior to their distribution. Alternatively, the art form may be forwarded directly to the participant via mail or e-mail. In addition, the art form may be resident on a webpage dedicated to the particular organization and downloadable therefrom.

While the above-described embodiment envisions the art forms, and thereby the artwork being scanned (converted to electronic format) subsequent to receipt, the present invention is not limited in this regard. The art forms can also be scanned by the artists, by someone on behalf of the artists, or by the organization and the scanned images forwarded electronically to the facilitating company. The artwork can also be created electronically. The present invention contemplates that the artwork can be created on an electronic version of the art form or in any other electronic format.

In another embodiment of the present invention, the above-described images created on behalf of an affinity group can take the form of paintings or photographs created at the behest of the facilitating company. In addition signed images by prominent figures such as sports figures, famous alumni and the like, can also be provided. The originals, or copies, such as posters or lithographs can also be offered as part of the fundraiser, as can commemorative plaques incorporating the images. In addition, the present invention contemplates these items being auctioned off on line either at a web site or web page established by or on behalf of the organization, or at an on-line auction site such as, but not limited to EBAY®.

The present invention also contemplates designating selected original artwork as embodied on custom postage as collectable. Submitted artwork would be reviewed by the facilitating company or by designers of the facilitating company. If a participant's original artwork is selected, custom items, including custom postage would be designated as collectable and offered for sale to the general public. The organization that originally conducted the fundraiser relevant to the particular selected piece of original artwork will then receive a portion of the proceeds of the sales to the general public. In addition, the artist responsible for the original artwork may be eligible to receive a scholarship.

In a related embodiment of the present invention, the art form is created by the fundraiser participants on-line. In this instance, the creator of the artwork, or if the creator is a child, or not computer literate, someone on behalf of the creator accesses a webpage established to provide instructions for and to facilitate scanning the artwork onto an on-line art form. Once the relevant webpage is accessed, the appropriate barcode, previously provided to the creator, is typed into an area provided on the webpage. The creator or other person is then walked through, via on-line instructions, the process of scanning the artwork from their home or other location. Once the artwork is scanned into the relevant webpage the creator or other person will also be able to, via online instructions, customize the particular item or items he/she wishes to order. For example, if custom postage is being ordered, the purchaser will be able to, on-line, change certain colors on the postage. If custom checks or mailing labels are ordered, the person may have the option of selecting different check or label backgrounds fonts and/or print colors. Similar modifications may also be made to other custom items offered as part of the fundraiser.

The present invention resides in another aspect in supplying prepaid postage postcards bearing the above-described original artwork thereon. The artwork can be enlarged and cover a substantial portion of a surface of the postcard or it can be of a size akin to a postage stamp and positioned on the postcard where a stamp would normally be placed. The postcards can be supplied as part of a fundraising event in lieu of, or in addition to the above-described custom postage.

Preferably, the fundraising event would be conducted as described herein; however, the present invention is not limited in this regard. This embodiment of the present invention contemplates that more than one original artwork image can be printed onto a postcard. For example, where a participant has created more than one piece of original artwork, these images can be printed onto the postcard. Moreover, the present invention contemplates two or more persons collaborating to create original artwork. The same postcard could include images of the collaborative artwork.

Moreover, the present invention further contemplates incorporating an image or photograph of the artist along with an image of the original artwork he/she created, on the postcard. While an image of the artist has been described, the present invention is not limited in this regard, as other images or photographs may also be employed. For example where the fundraiser is directed to raising money for an individual medical expense, a photograph of the recipient may be provided. Another example could be when a fundraiser is used to raise money for a scholarship bearing an individual's name; a photograph of the individual can be included on the postcard along with other original artwork.

Where the fundraising event is being conducted on behalf of an affinity group, the postcard can contain more than one of the above-described images relevant to the organization. In addition other images such as photographs or portraits of past, present or prominent members of the affinity group can also be incorporated into the post card.

In another aspect of the present invention, gift-to-donation program is contemplated. In exchange for a charitable contribution, a donor can be given an amount of custom postage. The custom postage can incorporate images created on behalf of an affinity group as described above. The custom postage can also include original artwork created in the above-described manner. The images on the custom postage can also include logos of such things as universities, clubs, sports team and the like.

The particular organization offering the custom postage in exchange for the charitable contribution can do so by pre-purchasing a quantity of the custom postage and, for example, can give a predetermined quantity of custom postage for a particular donation amount. Instead of having a quantity of custom postage on-hand, the particular organization upon receiving a sufficient donation can advise the company producing and/or facilitating the production of the custom postage, to ship a quantity of custom postage to the organization. The donor may be given a choice of images to be printed onto the custom postage. The donor depending on the applicable tax laws, may be able to take a tax deduction on all or a portion of the donation.

In addition to the foregoing, the present invention further contemplates that all or a substantial portion of the above-described donation process can be accomplished electronically. The donor can access a website to make their donation to a respective organization via a credit or debit card, or electronic funds transfer. Once the donation is made, custom postage relevant to the particular organization can be automatically sent to the donor. If there is a choice of images or original artwork that can be printed onto the custom postage, the donor can access this information on the website, make his/her choice of images and then the chosen custom postage can be forwarded to the donor. In order for the donor to access the website to make a donation, the donor can be required to give certain identifying information by entering the information into the appropriate places in the website. This information can be stored in a database along with information relevant to the organization to which the donation was made. The stored information can later be used by the organization to track donors and donations, to contact donors when funds are needed, and the like.

The present invention also resides in a social citizenship program wherein fundraising is conducted on behalf of organizations that provide monetary or other aid to people, populations, or segments of populations in need of financial or other aid. The entity conducting the fundraiser can be a school, church or other entity. The participants, typically children, create original artwork as described above; the artwork can be relevant to the particular cause for which funds are being raised. However, the present invention is not limited in this regard as the artwork can simply be unique to the individual. The original artwork would be created as set forth above and converted into an electronic format, or created electronically. Participants in the fundraiser, once their artwork is created could solicit orders for custom postage in the manner described herein above. In addition, the company facilitating the fundraiser can also establish a website or web page accessible via a website through which custom postage or other items bearing artwork can be ordered with at least a portion of the proceeds being donated to the charity.

This embodiment of the present invention also contemplates selecting one or more original artwork images to appear on custom postage, the images being relevant to the particular cause for which the fundraiser is being conducted.

In another aspect of the present invention, the facilitating company will establish a website having entertainment and educational components thereto. Access to the website will be allowed upon registration of an original artwork image to be converted into custom postage. However, the present invention is not limited in this regard as access to the website may be gained in other manners, such as, but not limited to being listed or registered as a participant in a fundraising event, the participant/registrants identifying information being stored in the above-described database.

Regardless of the manner in which the website is accessed, or the security protocols employed, access will be secure for minors. In order to provide such security, a minor's parent or guardian can be required to provide their e-mail address. The parent's or guardian's e-mail address will be associated with the relevant minor's information so that the parent or guardian can be copied on e-mails sent via the website, by or to the minor. In addition, the present invention also contemplates the website being monitored by at least one of the facilitating company, the website host and the parents or guardians of one or more of the minors accessing the website. Mechanisms for reporting suspicious or undesirable behavior will be in place to prevent or limit minors from being subjected to inappropriate content.

Once an individual qualifies, access to the website can be gained in several different manners. For example, the individual can be e-mailed a username and a password that upon accessing the website, must be entered to go further. It should be understood that as used herein, the term individual should be broadly construed to mean a participant/registrant's parent or guardian if the participant/registrant is a minor. In addition, other security measures such as hashing, answering questions unique to the individual, and the like may also be employed. An individual may also be given the ability to change their username and password. While having a username and password e-mailed to an individual has been described, the present invention is not limited in this regard as a username and password can also be sent to an individual via regular mail, fax, or via telephone. In lieu of a username and password an individual may be forwarded a code that can be entered once the individual enters the website. Upon entering the code, the user can either gain access to the website and/or be required to establish a username and a password.

Access to the website may also be allowed via the registration of virtual custom postage. For example, custom postage may have been previously created as part of a fundraiser. This custom postage can be registered on the website thereby allowing the registrant access thereto.

The website may include any number of interactive games and educational programs with one focus of the website being the promotion of literacy. Accordingly, the games and programs may be directed to enhancing reading or mathematical skills, however, the present invention is not limited in this regard. It is also contemplated that interacting with the programs or playing the games can earn the user points which can be accumulated and redeemed for such things as access to other areas of the website, redemption for web-related virtual items, or discounts on merchandise being offered on the website or by others advertising on the website or otherwise associated therewith. With respect to web-related virtual items, a user of the website may be given access to an area of the website unique to the particular user, for example, but not limited to, a virtual room. The user can redeem points to buy virtual items to furnish, and/or decorate, his/her virtual room. Access to the website can also be dependant on a user's performance in school. In addition, it is also contemplated that a user can gain points based on achieving certain grades on a report card. In addition, use of the website can provide the means whereby users qualify for regional and/or national scholarships. The use of the website can also allow users to obtain credits toward tuition at participating institutions.

One manner in which the website promotes literacy is via the establishment of a penpal system. In one embodiment of the penpal system, participants would register their original artwork and the virtual state in which they reside. The original artwork would be viewable in the form of a piece of custom postage. One objective of the penpal system being, as will be explained in greater detail below, for a participant to collect custom postage images from all fifty states in the United States. A participant collects these images by accessing an area of the website that contains other participant's custom postage images and the states with which the images are associated. The participant then chooses, by, for example, clicking on an image, another participants piece of custom postage. By choosing the image, the user is then able to draft an e-mail to the author of the chosen image. Software associated with the penpal system then evaluates the e-mail to verify that the e-mail meets certain criteria imposed by the software. These criteria can include such thing as, but are not limited to, checking grammar and spelling, determining that the e-mail meets a minimum word count, that the e-mail does not use abbreviations and verifying the appropriateness of the content of the e-mail. Once it is determined that the e-mail message meets the set criteria, the e-mail message is then sent to the desired recipient. Once the e-mail is sent, the sender will be given credit for the particular state with which the recipient is associated. The sender may view the states with which he/she has been given credit for by accessing a page or other area on the website where the custom postage images corresponding to the credited states can be viewed. As the user accumulates credit for different states, rewards can be given to the user. These rewards can be given for such things as, the most stamps collected, the largest geographic area covered. These rewards can include such things as, but are not limited to, discounts on merchandise, or qualification for a scholarship.

The present invention also contemplates providing a type of virtual auction on the above-described website. A user would enter his custom postage into the virtual auction along with others. User's could then vote for their favorite custom postage. The auction could be categorized with user's voting for their favorite custom postage within a particular category.

In addition to the rewards discussed thus far, the present invention also contemplates user's gaining the ability to access sites advertised on the facilitating companies website. The advertiser's would provide user's who have earned rewards with discounts to their services and/or merchandise.

The e-mail addresses associated with the penpal system can be provided by any service provider, or they can be provided by or on behalf of the facilitating company. If provided by or on behalf of the facilitating company, the individual given the e-mail address may be required to meet certain criteria to ensure that it is appropriate that they be given an e-mail address. These criteria can include such things as, but are not limited to, age verification, providing social security numbers, verification from the organization conducting a fundraiser that the person is actually a participant.

In addition to gaining an e-mail address in association with the above-described penpal system, the present invention also resides in providing e-mail addresses to users for a fee. The e-mail service would provide users with a safe environment whereby only other subscribers of the service could be e-mailed. Prior to being given an e-mail address, a user would have to be qualified. The qualification process may include such things as, but is not limited to age verification, obtaining parental permission, acceptable academic performance, recommendations from teachers or school administrators, and the like. The present invention also contemplates allowing user's to e-mail subscribers to other sites or services provided that these sites or services meet criteria that safeguards are in place to ensure a safe environment for users. These safeguards can include such things as, but are not limited to, monitoring of e-mails for appropriate content, monitoring e-mails for the use of certain words, and the like. In addition to e-mail, instant messaging can also be provided.

Because one of the objectives of providing e-mail access is to promote literacy, e-mail messages may have to meet certain criteria before they can be sent. For example, a minimum word count can be imposed. In addition, lists of vocabulary words can be provided and if used, rewards can be given, or the user could be prevented from sending e-mails that do not contain one or more of the vocabulary words. In addition, the use of abbreviations may also be prevented. The amount of time a particular user can spend on the website or e-mailing others may be limited. The website may also include additional security protocols wherein a parent or guardian, or other authorized person can be required to enter a password in addition to the user's password. Prompts requiring the entry of the additional password can also appear on the screen. These prompts can include such things as inquiring whether a user has done his/her homework and requires an e-mail from a parent or guardian validating the user's response.

It is further contemplated that the above-described website include advertising thereon. The advertising would have to be appropriate to the website. The advertising can be in the form of a banner ad, a pop-up advertisement, or a link to the advertiser's website. However, the present invention is not limited in this regard as the advertising may also be accessible via a links page on the website whereby a user can choose what advertisements to access. Any advertising or listings on the website would be appropriate to the content and theme of the website.

Access to the above-described facilitating companies website can be free with the registration of new custom postage each year, and/or a fee can be charged for yearly registration.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for providing access to and using an edutainment website; said method comprising the steps of:
registering original artwork created by one or more participants as part of a fundraising event, said original artwork being embodied in custom postage or postcards;
providing registrants or entities authorized to act on behalf of said registrants with instructions regarding how to access one of, a website or an area of a website, wherein said registrants can interact with educational and entertainment programming operable on said website; and
requiring protocols to be followed by said registrants or said entities acting on behalf of said registrants in order to allow access to said educational and entertainment programming.

2. A method as defined by claim 1 wherein said step of registering original artwork includes:
forwarding said original artwork to an entity facilitating said fundraising event, said entity facilitating said fundraising event entering information relevant to, said participant and said original artwork, into a database operable with software associated therewith to perform at least one of storing, tracking, and manipulating said information; and
said step of providing registrants or entities authorized to act on behalf of said registrants with instructions, further includes providing said registrants with at least one of a code, username, and password, that will allow said registrants to gain access to said educational and entertainment programming; and wherein
said step of requiring protocols to be followed by said registrants or said entities acting on behalf of said registrants includes entering at least one of said code, username, and password into a designated location on said website.

3. A method as defined by claim 1 comprising the further steps of:
posting images of said custom postage embodying original artwork thereon on an area of said website, said images having a state name and an e-mail address associated therewith;
providing programming associated with said website that allows a first registrant to select at least one image of said custom postage corresponding to a particular state;
said programming allowing said registrant to send an e-mail to a second registrant, said second registrant being associated with the selected image of said custom postage;
upon sending said e-mail, said programming storing information in said database identifying at least the state associated with said selected image; and
said programming being operable to identify the number of different states corresponding to images selected by said first registrant to which said first registrant has sent e-mails.

4. A method as defined by claim 3 comprising the further steps of:
giving said first registrant a reward upon sending e-mails to a predetermined number of states said e-mails being sent to e-mail addresses associated with said images selected by said first registrant.

5. A method as defined by claim 3 wherein said e-mail addresses are assigned by one of, an entity operating said website and an entity facility said fundraising event.

6. A method as defined by claim 3 wherein said e-mails must meet a minimum word count before said programming will allow said e-mails to be sent.

7. A method as defined by claim 3 further comprising the step of:
electronically reviewing said e-mails for appropriate content, said e-mails being rejected and unsent if content is determined to be inappropriate.

8. A method as defined by claim 3 comprising the further steps of:
providing a list of words to said first registrant for inclusion in said e-mail;
electronically reviewing said e-mails to search for the inclusion of one or more of said words; and
sending said e-mail upon verifying that a predetermined number of said words are in said e-mail.
